(19) United States
(12) Patent Application Publication
(10) Pub. No.: US 2010/0130348 A1
(43) Pub. Date: May 27, 2010

(54) PHOTOCATALYTIC COMPOSITION FOR ANTI-REFLECTION AND THE GLASS SUBSTRATE COATED WITH THE COMPOSITION

(76) Inventors: Chul-Hyun Kang, Incheon (KR); Ho-Hyun Song, Gyeonggi-do (KR); Seung-Ho Baek, Gyeonggi-do (KR); Si-Won Kim, Incheon (KR); Wan-In Lee, Seoul (KR); Hyoung-Ho Lee, Incheon (KR)

Correspondence Address: IPLA P.A., 3550 WILSHIRE BLVD., 17TH FLOOR, LOS ANGELES, CA, 90010, US

(21) Appl. No.: 12/597,982

(22) PCT Filed: Nov. 28, 2007
(86) PCT No.: PCT/KR07/06060

§ 371 Date: Oct. 28, 2009

(30) Foreign Application Priority Data
Sep. 21, 2007 (KR) 10-2007-0096245

(51) Int. Cl. B01J 31/02

(52) U.S. Cl. 502/172

(57) ABSTRACT

Disclosed herein is an antireflective photocatalyst composition including a titanium dioxide-based photocatalyst, a binder, water, and alcohol, and a substrate using the composition. The antireflective photocatalyst composition is advantageous in that, when it is applied to a glass substrate, such as a glass antireflective film for a solar cell or a glass illuminator, it can prevent incident light energy from scattering and improve optical transmissivity, and in that it decomposes pollutants due to the dual action of harmful gas decomposition and self-purification, which are specific characteristics of a photocatalyst.

### TECHNICAL FIELD

The present invention relates to an antireflective photocatalyst composition, through which light can be easily transmitted, and which can efficiently eliminate pollutants using a photocatalyst, and a glass substrate fabricated using the photocatalyst composition, in the field of glass substrates, such as glass antireflection films used for solar cells, glass illuminators, and the like.

### BACKGROUND ART

Generally, research for improving the transmissivity of glass illuminators by maximizing the transparency of raw materials, such as glass, acrylate, polycarbonate, etc., or research for improving the transmissivity of glass antireflection films using a porous SiO₂ layer has been conducted. However, such research is limited to maximizing the transparency of raw materials, and the effect of improving the trans-missivity of glass antireflection films using the porous layer is slight.

Therefore, currently, research for increasing the transmissivity of glass products by forming an additional surface coating layer thereon is being conducted together with research for increasing the transmissivity of glass products by improving the transparency of raw materials. A conventional antireflective coating usually consists of a stack of interferential thin layers, in which dielectric-based layers having high and low refractive indices are alternately disposed. The function of such a coating when deposited on a transparent substrate, is to decrease its light reflection coefficient and hence to increase its light transmission coefficient. Therefore, the transparent substrate thus coated therefore has a higher transmitted light/reflected light ratio, which improves the visibility of objects placed behind it.

Korean Registered Patent No. 183429, entitled “Glass surface treatment liquid and method of preparing the same”, discloses a glass surface treatment liquid for a TV Braun tube, comprising silicon alkoxide, water, alcohol and a catalyst, wherein the glass surface treatment liquid comprises 0.01˜5 wt % of glass powder and 1˜20 wt % of conductive metal particles. Here, when the glass surface treatment liquid is applied on the surface of glass, a transparent conductive film is formed thereon, thus exhibiting low reflective performance and a high antistatic effect.

Korean Registered Patent No. 474585, entitled “Glazing pane having an anti-reflection coating”, discloses a glazing pane, comprising: an “A” antireflection coating on at least a first external face thereof and an “A′” antireflection coating on a second external face thereof, wherein each of the “A” and “A′” antireflection coatings consist essentially of a stack of layers of materials having alternately high and low refractive indices, and at least some of the layers of each of the stacks are pyrolyzed layers, and wherein the low-refractive-index layers 3, 6, 8 and 10 in the antireflection stack have a refractive index of between 1.38 and 1.65, the high-refractive-index layers 2, 5, 7 and 9 therein have a refractive index of between 1.85 and 2.60, and, due to the optical thicknesses of the layers of the “A” and “B” antireflection stacks, the light reflection (RL) is reduced to values of less than 1.5% upon normal incidence.

Korean Registered Patent No. 653585, entitled “Antireflective film, preparation method thereof, and antireflective glass”, discloses an antireflective coating film comprising two types of silicon compounds and other compounds.

### DISCLOSURE OF INVENTION

### Technical Problem

Accordingly, the present invention has been made keeping in mind the above problems occurring in the prior art, and an object of the present invention is to provide an antireflective photocatalyst composition, by which the transmissivity of a glass reflective film of an illuminator or solar cell is improved at an early stage by the application of a photocatalyst thereto, and by which the transmissivity of a coating film can be maintained high even after the passage of time because the contamination of the coating film is prevented due to the dual effect of harmful gas decomposition and superhydrophilic phenomena depending on the specific characteristics of a photocatalyst, and a glass substrate using the photocatalyst composition.

### Technical Solution

The present invention provides an antireflective photocatalyst composition including a titanium dioxide-based photocatalyst, a binder, water, and an alcohol.

Further, the antireflective photocatalyst composition may include 10˜40 parts by weight of the binder, 300˜500 parts by weight of the water, and 1000˜2000 parts by weight of the alcohol, based on 1 part by weight of the titanium dioxide-based photocatalyst.

Further, the titanium dioxide-based photocatalyst may be titanium dioxide; a composite catalyst of titanium dioxide and WO₃, ZnO, SnO₂, CdS, or ZrO₂; or TiO₍₂₋ₓ₎ Nₓ, in which titanium dioxide is doped with nitrogen.

Further, the binder may be an alkoxysilane-based binder or an inorganic silane-based binder.

Further, the alkoxysilane-based binder may be any one selected from among tetrapropyl orthosilicate [Si(OPr)₄], tetraethyl orthosilicate [Si(OEt)₄], tetramethyl orthosilicate [Si(OMe)₄], and aminosilane.

Further, the present invention provides a glass substrate coated with the antireflective photocatalyst composition.

In particular, the glass substrate may be a solar light antireflection film, or a glass illuminator.

In particular, the antireflective photocatalyst composition may be applied on the glass substrate using any one of spray coating impregnation, roll coating and cloth or sponge coating.

In particular, the antireflective photocatalyst composition is applied on the glass substrate, and is then thermally cured at a temperature of 80˜150° C.

### Advantageous Effects

The antireflective photocatalyst composition according to the present invention is advantageous in that it prevents incident light energy from scattering and improves optical transmissivity, and in that it decomposes pollutants due to the dual action of harmful gas decomposition and self-purification, which are specific characteristics of a titanium dioxide photocatalyst, such that they are not layered on an electrically-used illuminator or a solar cell, and increases light efficiency, thus maximizing economic effects. Further, the antireflective photocatalyst composition according to the present invention is advantageous in that it maintains high hardness, and thus it is not easily scratched or peeled off when used in adverse environments.

### BRIEF DESCRIPTION OF THE DRAWINGS

FIG. 1 is a graph showing the experimental results of measuring the transmissivities of glass test pieces prepared in Examples 2 to 4 using a UV-Vis spectrophotometer;

FIG. 2 is a graph showing the transmissivity changes in the surface of glass coated with a photocatalyst and glass not coated therewith when the sample of Example 2 is irradiated using a ceramic metal halogen (CMH) lamp as a light source;

FIG. 3 is a graph showing the transmissivity changes in the surface of glass coated with a photocatalyst and glass not coated therewith when the sample of Example 3 is irradiated using a ceramic metal halogen (CMH) lamp as a light source;

FIG. 4 is a graph showing the transmissivity changes in the surface of glass coated with a photocatalyst and glass not coated therewith when the sample of Example 4 is irradiated using a ceramic metal halogen (CMH) lamp as a light source;

FIG. 5 is a graph showing the transmissivity changes in the surface of glass coated with a photocatalyst and glass not coated therewith when the sample of Example 2 is irradiated using a three-wavelength fluorescent lamp as a light source;

FIG. 6 is a graph showing the transmissivity changes in the surface of glass coated with a photocatalyst and glass not coated therewith when the sample of Example 3 is irradiated using a three-wavelength fluorescent lamp as a light source;

FIG. 7 is a graph showing the transmissivity changes in the surface of glass coated with a photocatalyst and glass not coated therewith when the sample of Example 4 is irradiated using a three-wavelength fluorescent lamp as a light source;

FIG. 8 is a view showing the change in the water contact angle of a photocatalytic glass test piece coated with oleic acid, used as the photocatalyst of the present invention, after UV irradiation thereof for 12 hours;

FIG. 9 is a graph showing the change in the water contact angle of samples of Example 2 of the present invention depending on the photodecomposition of oleic acid;

FIG. 10 is a graph showing the change in the water contact angle of the samples of Example 4 of the present invention depending on the photodecomposition of oleic acid;

FIG. 11 is a graph showing the decrease in the concentration of 2-propanol with the passage of time based on the photodecomposition effect of the samples of Example 4 of the present invention;

FIG. 12 is a graph showing the increase in the formation of carbon dioxide (CO₂) with the passage of time based on the photodecomposition effect of the samples of Example 4 of the present invention; and

FIG. 13 is a graph showing the increase in the formation of acetone with the passage of time based on the photodecomposition effect of the samples of Example 4 of the present invention.

### BEST MODE FOR CARRYING OUT THE INVENTION

The present invention provides an antireflective photocatalyst composition which is used for glass antireflective films for solar cells, glass illuminators, etc., and, more particularly, provides a highly antireflective photocatalyst composition including titanium dioxide, functioning as a photocatalyst, an alkoxysilane-based binder or an inorganic silane-based binder, serving to increase the strength of a coating film formed on a glass substrate and to enable the antireflective photocatalyst composition to be easily applied thereon, and water and alcohol, serving as a solvent, by which harmful gases can be easily decomposed.

In the present invention, it is preferred that titanium dioxide or a composite catalyst of titanium dioxide and WO₃, ZnO, SnO₂, CdS, or ZrO₂, or TiO₍₂₋ₓ₎Nₓ, in which titanium dioxide is doped with nitrogen, be used as a titanium dioxide-based photocatalyst.

For example, a TiO₂—WO₃ catalyst, which is a composite catalyst of TiO₂ and WO₃, may be produced using the method disclosed in Korean Registered Patent No. 578044, filed by the present applicant. This Korean Registered Patent No. 578044 disclose a method of producing a visible photocatalyst, in which titanium dioxide is combined with tungsten oxide, comprising the steps of: i) synthesizing WOx nanoparticles having a diameter of 1.0˜1000 nm or WOx nanorods having a diameter of 1.0˜100 nm (where x is 2.0˜3.0 and the length of the nanorod is 10 times the diameter thereof or more); ii) dispersing the WOx nanoparticles or WOx nanoparticles in an aqueous solution together with TiO₂ nanoparticles, or dispersing them in a TiO₂ solution prepared through a sol-gel process to form a mixed solution; and iii) drying the mixed solution to remove a solvent therefrom and then heat-treating the dried mixed solution at a temperature of 100˜800° C.

In the present invention, in order to adhere the antireflective photocatalyst composition closely to a glass substrate, a binder having good compatibility with glass, such as an alkoxysilane-based binder or an inorganic silane-based binder, may be used. In particular, the alkoxysilane-based binder may be any one selected from among tetrapropyl orthosilicate [Si(OPr)₄], tetraethyl orthosilicate [Si(OEt)₄], tetramethyl orthosilicate [Si(OMe)₄], and aminosilane.

### Mode for the Invention

Hereinafter, the present invention will be described in detail with reference to Examples.

A better understanding of the present invention may be obtained through the following examples, which are set forth to illustrate, but are not to be construed as the limit of the present invention.

### Example 1

### Preparation of Antireflective Photocatalyst Composition

WO₃—TiO₂ photocatalyst powder was prepared through the method disclosed in Korean Registered Patent No. 578044, filed by the present applicant. The prepared WO₃—TiO₂ photocatalyst powder had a primary particle size of about 20 nm and a secondary particle size of about 120 nm. The prepared WO₃—TiO₂ photocatalyst powder was formed into a 1% aqueous photocatalyst solution. A binder having good compatibility with glass and a photocatalyst solution was required in order to fix the photocatalyst on a glass substrate. A 5% inorganic binder solution was prepared by adding tetraethyl orthosilicate to a solvent consisting of ethanol and isopropyl alcohol at room temperature to form a mixed solution and then reacting the mixed solution while heating it to a temperature of 50° C. Subsequently, the prepared photocatalyst and binder were mixed with water and ethanol at a ratio of photocatalyst:binder:water:ethanol of 1:4:3:9, and then the resulting mixture was stirred, thereby preparing a superhydrophilic photocatalyst composition for decomposing harmful gases.

### Examples 2 to 4

### Preparation of Glass Test Pieces Coated with the Antireflective Photocatalyst Composition

Three glass test pieces having a large size of 100 mm×100 mm×5 mm and nine test pieces having a small size of 50 mm×50 mm×3 mm were prepared using commercially available glass. Half of the large sized glass test pieces and all of the small sized glass test pieces were coated with the photocatalyst solution synthesized in Example 1 at application rates of 40, 80, and 120 ml/m², respectively, using an automatic sprayer having a diameter of 0.8 mm, and were then cured in a drying oven at a temperature of 80˜150° C. for 5 minutes, thereby preparing glass test pieces coated with the antireflective photocatalyst composition. Subsequently, the physical properties of the prepared glass test pieces coated with the antireflective photocatalyst composition were measured.

### Experimental Example 1

### UV-Vis Spectrophotometer Test

The transmissivities of glass not coated with the photocatalyst composition (the curve indicated by “nature” in FIG. 1), a glass test piece coated with the photocatalyst composition at an application rate of 40 ml/m² of Example 2, a glass test piece coated with the photocatalyst composition at an application rate of 80 ml/m² of Example 3, and a glass test piece coated with the photocatalyst composition at an application rate of 120 ml/m² of Example 4 were measured at wavelengths ranging from 350 nm to 900 nm using a UV-Vis Spectrophotometer (10e, manufactured by Cintra Corp.).

The transmissivities in Experimental Examples 1 and 2 were calculated using the following Equation 1.

Transmissivity (%)=(intensity of light having passed substrate/light intensity of initial light source)×100 (Equation 1)

The difference in transmissivity between the surface of glass coated with photocatalyst and the surface of glass not coated therewith was calculated using the following Equation 2.

Difference in transmissivity=transmissivity of the surface of glass coated with photocatalyst−transmissivity of the surface of glass (Equation 2)

The rate of increase of transmission was calculated using the following Equation 3.

Transmission increase rate (%)=(difference in transmissivity/transmissivity of surface of glass)×100 (Equation 3)

As shown in FIG. 1, it was found that the transmissivity of the glass test piece coated with the photocatalyst composition at an application rate of 40 ml/m² of Example 2 decreased at wavelengths below 400 nm and increased at wavelengths above 400 nm, and the transmissivity of the glass test piece coated with the photocatalyst composition at an application rate of 80 ml/m² of Example 3 decreased at wavelengths below 460 nm and increased at wavelengths above 460 nm, but the transmissivity of the glass test piece coated with the photocatalyst composition at an application rate of 120 ml/m² of Example 4 decreased at wavelengths below 680 nm and increased at wavelengths above 680 nm because the absolute amount of the photocatalyst was increased.

Referring to FIG. 1, at a wavelength of 600 nm, the transmissivity of the glass test piece coated with the photocatalyst composition at an application rate of 40 ml/m² of Example 2 was increased to 1.6%, the transmissivity of the glass test piece coated with the photocatalyst composition at an application rate of 80 ml/m² of Example 3 was increased to 1.0%, and the transmissivity of the glass test piece coated with the photocatalyst composition at an application rate of 120 ml/m² of Example 4 was decreased to 0.3%.

### Experimental Example 2

### Transmissivity Test

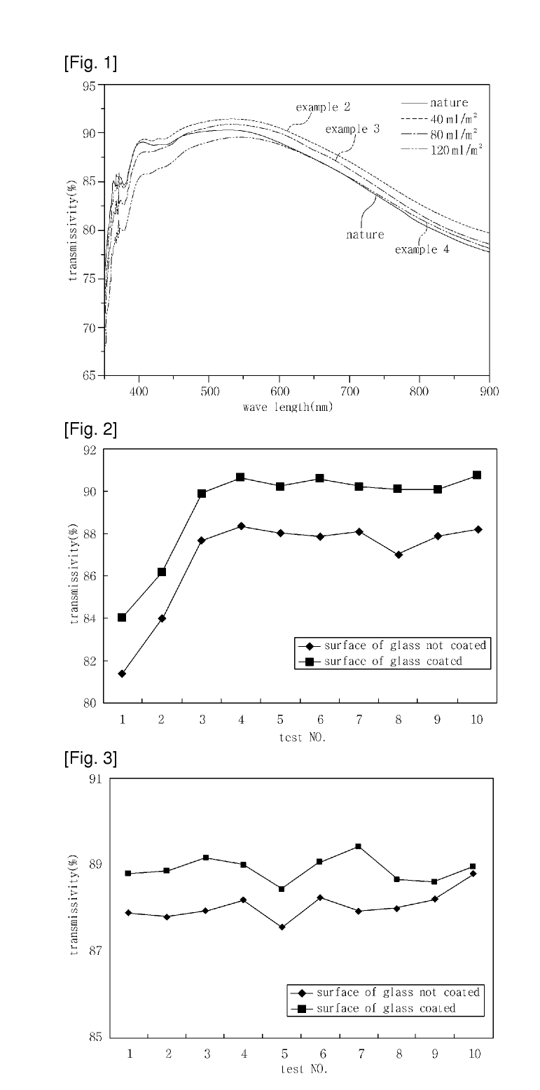

Tests for measuring transmissivity attributable to a photocatalyst (formation of antireflective film) were conducted in a dark box, painted black in order to minimize light dispersion and reflection effects from surrounding light sources. Two lamps provided in the upper portion of the dark box, specifically, a ceramic metal halogen (CMH) lamp and a three-wavelength fluorescent lamp, were used as the light sources. In this case, since the light emitted from the CMH lamp was excessively strong the transmissivity thereof was measured using primarily reflected light. First, the illuminance (Lx) of light emitted from the light source was measured using an illuminometer (1330, manufactured by TES Corp.). Subsequently, the illuminances of the light having passed through the surface of a glass test piece not coated with the photocatalyst and the surface of a glass test piece coated with the photocatalyst were both measured, and then the transmissivity of each of the glass test pieces was determined by dividing the illuminance of each of the glass test pieces by the illuminance of the initial light source. FIGS. 2 to 4 show the results of measuring the transmissivity of samples of Example 2 to 4 (here, large glass test pieces were used, and the application rates thereof were 40, 80, and 120 ml/m², respectively) using the CMH lamp as a light source, and FIGS. 5 to 7 show the results of measuring the transmissivity of the samples of Example 2 to 4 using the three-wavelength fluorescent lamp as a light source.

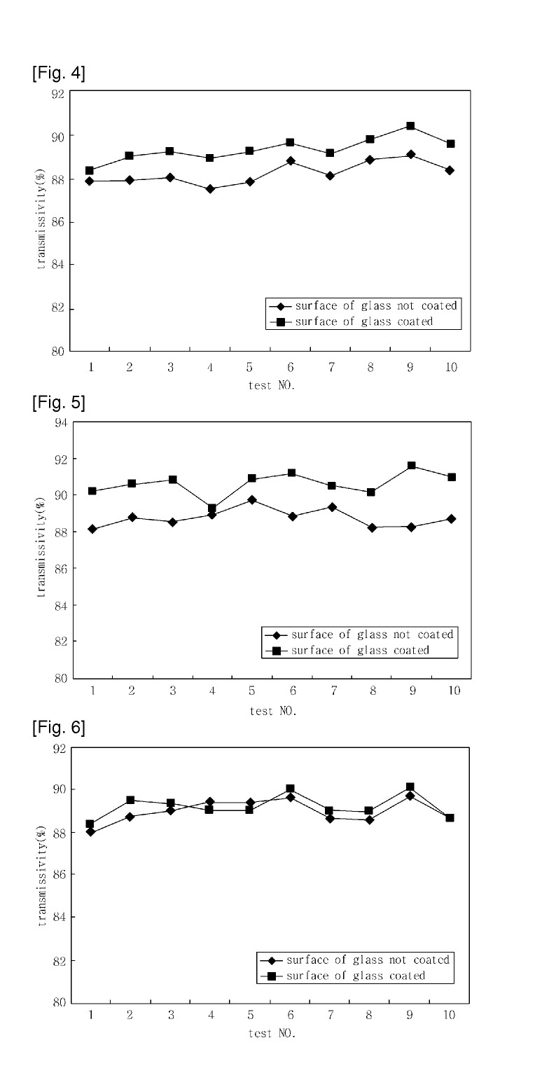

FIGS. 2 to 4 are graphs showing the transmissivity difference in the surfaces of glass not coated with a photocatalyst and glass coated with a photocatalyst when the samples of Examples 2 to 4 are irradiated using the ceramic metal halogen (CMH) lamp as a light source. As shown in FIG. 2, the sample of Example 2 exhibits the highest transmissivity when a glass test piece is coated with a photocatalyst at an application rate of 40 ml/m², and the transmissivity thereof is increased to 2˜3%. As shown in FIG. 3, the transmissivity of the sample of Example 3 is increased to about 1%. As shown in FIG. 4, the transmissivity of the sample of Example 4 is increased to about 1.2%.

In particular, it can be seen that the transmissivity thereof is increased much more at low illuminance using reflected light. It is understood that the transmissivity of incident light is improved due to the difference in refractive index between titanium dioxide and silicate in consideration of the structure of photocatalytic nanomaterials. Further, considering that the transmissivity of the sample of Example 3 in FIG. 3 is improved more than that of the sample of Example 4 in FIG. 4, it can be seen that the transmissivity thereof changes depending on the amount of the photocatalyst that is applied thereto. However, the results thereof are different from the general prediction that light is blocked by haze attributable to a photocatalyst.

In summary, in order to test the transmissivity of the glass test pieces of Examples 2 to 4, the transmissivity of large glass test pieces was measured using a ceramic metal halogen (CMH) lamp. As a result, the transmissivity of the glass test piece coated with the photocatalyst composition of the present invention in Example 2 was observed to increase to 2.79%, compared to that of the glass test piece not coated with the photocatalyst composition of the present invention, the transmissivity of the glass test piece coated with the photocatalyst composition of the present invention in Example 3 was observed to increase to 0.96%, compared to that of the glass test piece not coated with the photocatalyst composition of the present invention, and the transmissivity of the glass test piece coated with the photocatalyst composition of the present invention in Example 4 was observed to increase to 1.23%, compared to that of the glass test piece not coated with the photocatalyst composition of the present invention.

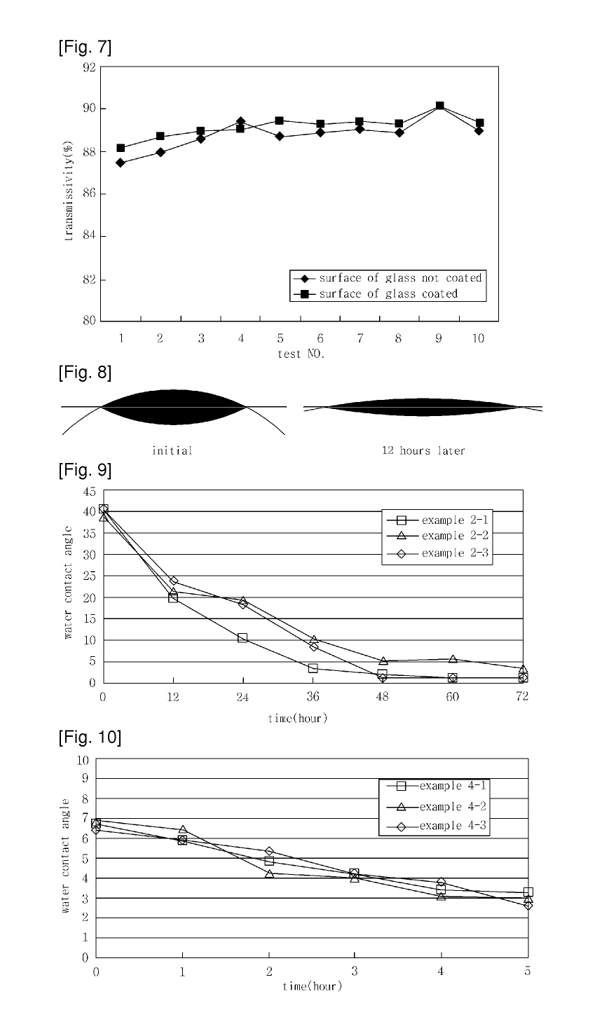

Meanwhile, when a three-wavelength fluorescent lamp was used, in Example 2, the transmissivity of the glass test piece coated with the photocatalyst composition was observed to increase to 2.08%, compared to that of the glass test piece not coated with the photocatalyst composition (see FIG. 5), in Example 3, the transmissivity of the glass test piece coated with the photocatalyst composition was observed to increase to 0.25%, compared to that of the glass test piece not coated with the photocatalyst composition (see FIG. 6), and in Example 4, the transmissivity of the glass test piece coated with the photocatalyst composition was observed to increase to 0.42%, compared to that of the glass test piece not coated with the photocatalyst composition (see FIG. 7).

From the results of Experimental Example 1, using the UV-Vis Spectrophotometer, and Experimental Example 2, it can be seen that the transmissivity of the glass test piece coated with the photocatalyst composition of the present invention was improved.

In particular, since the CMH lamp or the three-wavelength fluorescent lamp emits a negligible quantity of ultraviolet radiation, the transmissivity of the glass test piece is chiefly influenced by visible radiation. Further, since sunlight emits less than 5% ultraviolet rays, the transmissivity thereof is also influenced by visible radiation. Therefore, it is expected that the results of Experimental Examples 1 and 2 will be the same as those obtained using sunlight as a light source.

### Experimental Example 3

### Physical Strength of Photocatalyst-Coated Film

The strengths of the photocatalyst-coated films formed on the glass test pieces prepared in Examples 2 to 4 were measured using a pencil hardness tester (weight: 1 kg, pencil inclination angle: 45 degrees), and the surface damage thereof was observed at 400× magnification using a phase difference microscope. All of the glass test pieces exhibited film strength of 7H or more, and the photocatalyst-coated film was not separated from the glass test piece even when the photocatalyst-coated film was rubbed with wet wipes 50 times or more in a state in which the surface thereof was wet.

### Experimental Example 4

### Test for Evaluating Superhydrophilic Property Depending on Photodecomposition of Oleic Acid Through a Photocatalyst

The evaluation of the superhydrophilic property of the glass test piece of Examples 2 and 4 was conducted according to the following testing method (JIS R1703-1). Glass test pieces were prepared by dipping glass into 5% by volume of a mixed solution of oleic acid (95% or more, available from Daejung Chemicals and Metals Co., Ltd.) and heptane (98% or more, available from Daejung Chemicals and Metals Co., Ltd.) through a dip coating method (extension rate: 60 cm/min). Thereafter, the prepared glass test pieces were dried in a drying oven at a temperature of 70° C. for 15 minutes, and then left in a dark chamber for 12 hours. In order to evaluate the hydrophilic property of the glass test piece, the water contact angles between a glass substrate and water drops, which formed when 1 μl of distilled water was dropped on the surface of the glass test piece, were measured using a water contact angle meter (DSA-100, manufactured by KRUSS Corp. in Germany). After the initial water contact angles were measured, the changes in the water contact angle depending on the period of ultraviolet irradiation (BLB lamp (UV-A), 1 mW/cm²) were measured five times while changing the position of the glass test pieces. In this measurement, it was found that the photodecomposition of oleic acid differed partly due to the difference in the formation of photocatalyst-coated films through the dip coating method. FIG. 8 shows the water contact angle between the glass substrate and the water drops after UV irradiation thereof for 12 hours. From FIG. 8, it can be seen that the water drops spread more with the passage of time. The reason why this phenomenon occurs is that organic materials decompose from glass coated with oleic acid through a photocatalytic reaction, and, simultaneously, a photocatalyst applied on the surface of glass is activated by light and thus reacted with water in air, enabling hydrogen bonds to be easily formed, thereby causing hydrophilization. As shown in FIG. 9, in the case where the water contact angle in the glass test piece of Example 2 was measured three times, the initial water contact angle thereof was about 40 degrees (in FIG. 9, Examples 2-1, 2-2 and 2-3 mean the results of three tests in Example 2), and after ultraviolet irradiation was conducted for 48 hours, the water contact angle thereof was 5 degrees or less, thus indicating a superhydrophilic property. In contrast, as shown in FIG. 10, in the case where the water contact angle in the glass test piece of Example 4 was measured three times, the initial water contact angle therein was about 6˜7 degrees (in FIG. 10, Examples 4-1, 4-2 and 4-3 mean the results of three tests in Example 4), and after ultraviolet irradiation was conducted for 3˜5 hours, the water contact angle therein was less than 5 degrees, thus indicating a superhydrophilic property. Therefore, it can be seen that the photodecomposition of oleic acid was accelerated depending on the amount of the photocatalyst that was applied.

### Experimental Example 5

### Test for Decomposing Organic Gas using a Photocatalystcoated Film

Photocatalytic activity leading to the decomposition of harmful gases was measured using the small glass test piece prepared in Example 4 as follows.

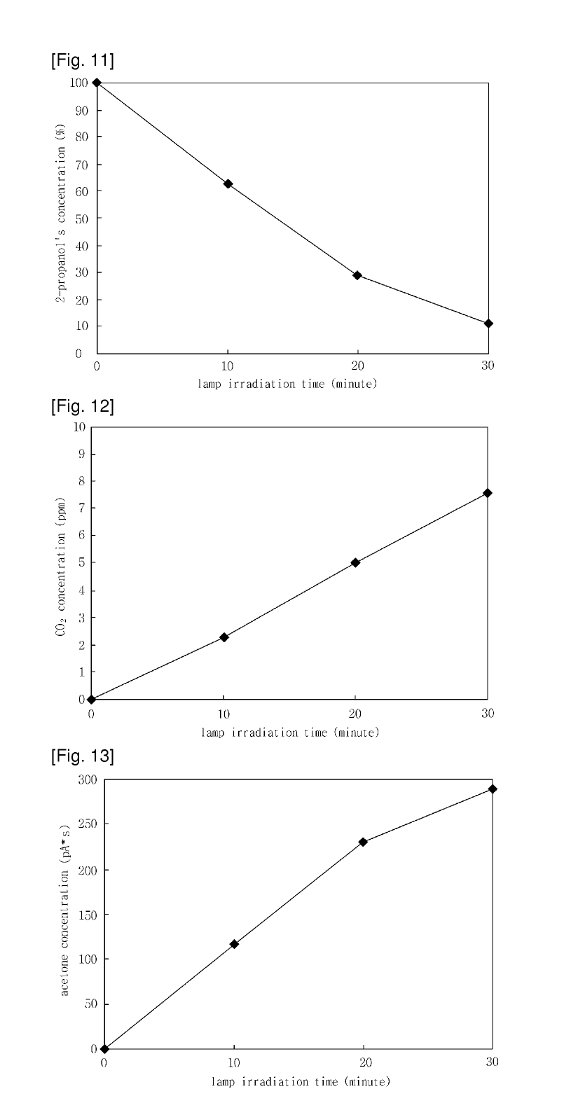

The sample was put into a reactor filled with 2-propanol at 250 ppm. The 2-propanol was decomposed through a photocatalytic reaction while the reactor was irradiated with a 7W Xe lamp. The concentrations of acetone, which is an intermediate formed while the 2-propanol decomposes, and carbon dioxide, which is a final product formed upon decomposition of the 2-propanol, were measured using gas chromatography. FIG. 11 shows the decrease in the concentration of 2-propanol over time due to the photodecomposition thereof, FIG. 12 shows the increase in the concentration of carbon dioxide (CO2) over time through the photodecomposition of 2-propanol, and FIG. 13 shows the increase in the concentration of acetone over time through the photodecomposition of 2-propanol.

From the results of Experimental Example 5, it can be seen that the photocatalystcoated film exhibits excellent degradation capability in consideration of the characteristics of a transparent photocatalyst solution for glass having high hardness.

### INDUSTRIAL APPLICABILITY

The antireflective photocatalyst composition of the present invention can be used in various glass products, such as solar cells, illuminators, etc., as an antireflective coating film.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An antireflective photocatalyst composition, comprising a titanium dioxide-based photocatalyst, a binder, water, and an alcohol.

2. The antireflective photocatalyst composition according to claim 1, wherein the composition comprises 10˜40 parts by weight of the binder, 300˜500 parts by weight of the water, and 1000˜2000 parts by weight of the alcohol, based on 1 part by weight of the titanium dioxide-based photocatalyst.

3. The antireflective photocatalyst composition according to claim 1, wherein the titanium dioxide-based photocatalyst is titanium dioxide, a composite catalyst of titanium dioxide and WO₃, ZnO, SnO₂, CdS, or ZrO₂; or TiO₍₂₋ₓ₎ Nₓ, in which titanium dioxide is doped with nitrogen.

4. The antireflective photocatalyst composition according to claim 3, wherein the titanium dioxide-based photocatalyst is a composite catalyst of TiO₂ and WO₃.

5. The antireflective photocatalyst composition according to claim 1, wherein the binder is an alkoxysilane-based binder or an inorganic silane-based binder.

6. The antireflective photocatalyst composition according to claim 5, wherein the alkoxysilane-based binder is any one selected from among tetrapropyl or thosilicate [Si(OPr)₄], tetraethyl orthosilicate [Si(OEt)₄], tetramethyl orthosilicate [Si(OMe)₄], and aminosilane.

7. A glass substrate coated with the antireflective photocatalyst composition according to claim 1.

8. The glass substrate according to claim 7, wherein the glass substrate is a solar light antireflection film or a glass illuminator.

9. The glass substrate according to claim 7, wherein the antireflective photocatalyst composition is applied on the glass substrate using any one of spray coating, impregnation, roll coating, and cloth or sponge coating.

10. The glass substrate according to claim 7, wherein the antireflective photocatalyst composition is applied on the glass substrate and is then thermally cured at a temperature of 80˜150° C.

11. A glass substrate coated with the antireflective photocatalyst composition according to claim 2.

12. A glass substrate coated with the antireflective photocatalyst composition according to claim 3.

13. A glass substrate coated with the antireflective photocatalyst composition according to claim 4.

14. A glass substrate coated with the antireflective photocatalyst composition according to claim 5.

15. A glass substrate coated with the antireflective photocatalyst composition according to claim 6.
